(19) United States
(12) Patent Application Publication
(10) Pub. No.: US 2007/0153993 A1
(43) Pub. Date: Jul. 5, 2007

(54) MONITORING METHOD AND SYSTEM

(75) Inventor: Philip E. Cohen, Toronto, ON (CA)

Correspondence Address: BERESKIN AND PARR, 40 KING STREET WEST, BOX 401, TORONTO, ON, M5H 3Y2, CA

(73) Assignee: MOBILE REACH MEDIA INC., Toronto, ON (CA)

(21) Appl. No.: 11/676,010

(22) Filed: Feb. 16, 2007

Related U.S. Application Data
(63) Continuation-in-part of application No. 11/045,335, filed on Jan. 31, 2005, now abandoned.
(60) Provisional application No. 60/540,346, filed on Feb. 2, 2004.
(60) Provisional application No. 60/783,393, filed on Mar. 20, 2006.

(51) Int. Cl. H04M 11/04; H04M 11/00

(52) U.S. Cl. 379/100.05; 379/38

(57) ABSTRACT

A system and method for monitoring a monitored subject is disclosed. In a broad aspect, the method comprises activating a monitoring service to send notification messages to the monitored subject, sending at least one notification message to a monitored subject in accordance with a first notification schedule, determining if a response to the at least one notification message sent at the sending step is received from the monitored subject within a pre-specified time period, and invoking a non-response system state when a response to the at least one notification message is not received from the monitored subject within the pre-specified time period, wherein a non-response message is sent to a monitoring party at the invoking step. Various features of the system and method are disclosed herein.

### CROSS REFERENCE TO RELATED APPLICATIONS

This application is a continuation-in-part of prior application Ser. No. 11/045,335, filed Jan. 31, 2005, which claims the benefit of U.S. Provisional Application No. 60/540,346, filed Feb. 2, 2004. This application also claims the benefit of U.S. Provisional Application No. 60/783,393, filed Mar. 20, 2006. The contents of prior application Ser. No. 11/045,335, U.S. Provisional Application No. 60/540,346, and U.S. Provisional Application No. 60/783,393 are hereby incorporated by reference.

### TECHNICAL FIELD

Embodiments described herein relate generally to a system and method for monitoring one or more persons.

### BACKGROUND

A number of methods and systems adapted to perform monitoring functions exist in the prior art, such as those described in U.S. Pat. No. 6,593,851 and U.S. Publication No. 2003/0091158, for example.

### SUMMARY

In a broad aspect, there is provided a method of monitoring a monitored subject comprising the steps of: activating a monitoring service to send notification messages to the monitored subject; sending at least one notification message to the monitored subject, via a mobile communication device of the monitored subject, in accordance with a first notification schedule; determining if a response to the at least one notification message sent at the sending step is received from the monitored subject via the mobile communication device within a pre-specified time period; and invoking a non-response system state when a response to the at least one notification message is not received from the monitored subject within the pre-specified time period, wherein a non-response message is sent to a monitoring party at the invoking step.

### BRIEF DESCRIPTION OF THE DRAWINGS

For a better understanding of the embodiments described herein, and to show more clearly how they may be carried into effect, reference will now be made, by way of example, to the accompanying drawings in which:

FIGS. 1 and 2 are schematic diagrams illustrating a monitoring system comprising a web site in accordance with at least one embodiment;

FIG. 3 is a schematic diagram illustrating a monitoring system in which the web site of FIGS. 1 and 2 is connected to a notification engine;

FIG. 4 is a schematic diagram illustrating the notification engine of FIG. 3 connected through communication links to contact locations of a monitored subject and a monitoring party;

FIG. 5 is a schematic diagram illustrating a monitoring system comprising the web site of FIGS. 1 and 2 in another embodiment; and

FIG. 6 is a flowchart illustrating steps in a method of monitoring a monitored subject in at least one embodiment.

### DETAILED DESCRIPTION

Embodiments described herein relate generally to a system and method for monitoring one or more persons. Implementations of these embodiments may facilitate the monitoring of such persons, hereinafter referred to as monitored subjects, by one or more monitoring parties in a variety of applications.

For instance, a parent or other guardian may worry about the safety of a child while that child is away from the home or outside of immediate supervision. The parent may wish to monitor the activities or whereabouts of the child. The child may be out for part of the day or night, away on vacation, or traveling, for example. As a further example, the child may be at home, possibly with a babysitter, while the parent is away from home. In that situation, the parent may also wish to confirm the well-being of the child.

Similarly, in another instance, an employer may wish to monitor the activities or whereabouts of an employee.

As a further example, a pharmaceutical clinical trial administrator may wish to monitor a patient, to confirm that the patient is adhering to a schedule for taking medication.

Some other example applications may be directed to the monitoring of individuals to ensure that they are performing certain tasks in a timely fashion.

Generally, as illustrated in the foregoing examples, a monitoring service may be useful when one or more monitoring parties (e.g. parent, employer, clinical trial administrator) are desirous of monitoring one or more monitored subjects (e.g. child, employee, patient), typically in situations where the monitoring parties are separated from the monitored subjects. The purpose of the monitoring may be to confirm the well-being or whereabouts of a monitored subject, the status in regards to the completion of a task, or some other application, for example.

The applications, monitoring parties, and monitored subjects described above are provided by way of example only, and it will be understood by persons of ordinary skill in the art that the embodiments described herein may be applied to other applications, monitoring parties, and/or monitored subjects.

Registration and Monitoring Service Configuration

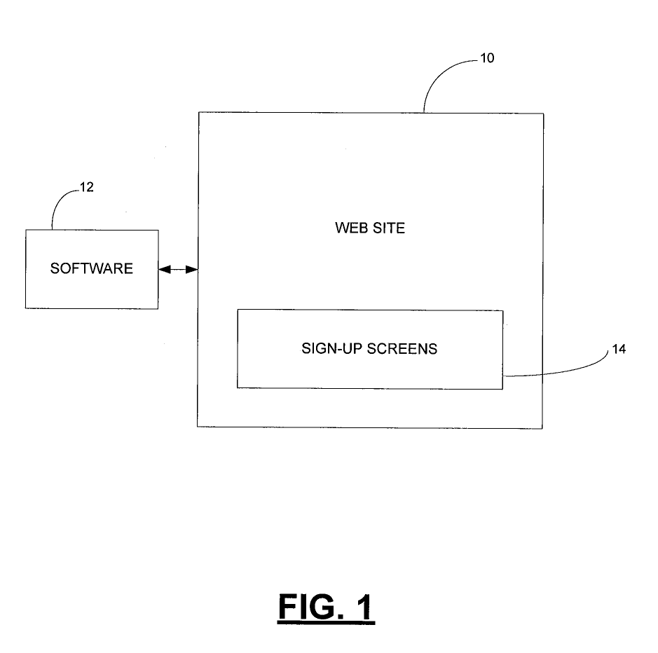

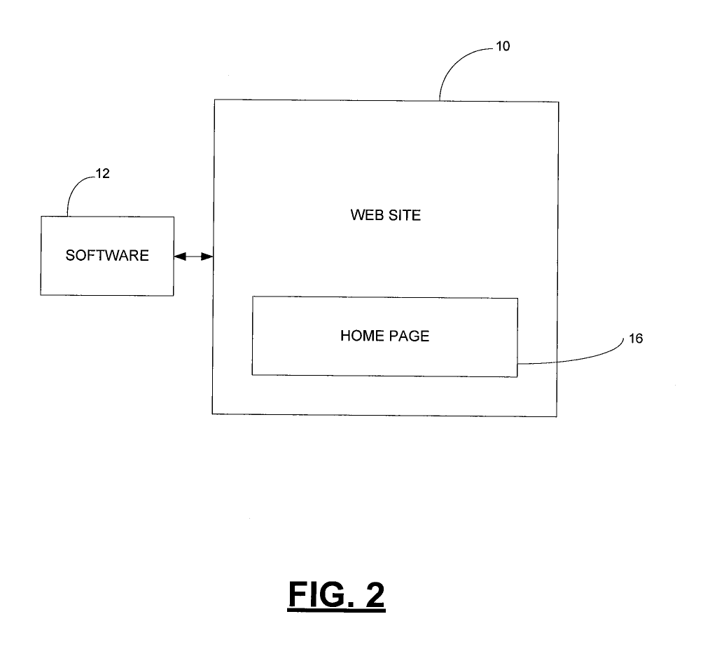

Referring now to FIGS. 1 and 2, schematic diagrams illustrating a monitoring system comprising a web site in accordance with at least one embodiment are provided.

In the monitoring system of FIGS. 1 and 2, a web site 10 is provided. The web site 10 may be made accessible via the Internet, for example. Operation of the web site 10 is controlled at least in part by software 12. The software 12 is programmed to provide interactive sign-up screens 14 (FIG. 1) where users may sign-up or register (these terms may be used interchangeably herein) for a monitoring service. A user that is registering for the monitoring service will typically be a monitoring party, although a user may alternatively be someone who registers for the monitoring service on behalf of the monitoring party.

Through the sign-up screens 14, the user is prompted for sign-up information, in order to configure the monitoring service for one or more monitored subjects and to provide additional information. The sign-up information will typically include at least a subset of the following data items, provided by way of example:

a monitoring party's mobile phone or other mobile device number;

a user name;

a password;

an e-mail address;

credit card information;

billing recurrence (e.g. monthly, yearly);

contact data for the monitoring party, for use when a monitored subject does not respond to the monitoring system, which may include, for example, an e-mail address, a short message service (SMS) number, wireless application protocol (WAP) details, a telephone number, and/or a pager number;

contact data for one or more alternate contact parties, for use when a monitored subject does not respond to the monitoring system and when the monitoring party cannot be contacted using the contact data for the monitoring party;

the number of monitored subjects that the monitoring party wishes to configure the monitoring service for, and an identifier to be associated with each monitored subject (e.g. name, nickname);

an indication (e.g. a flag to be set by the user) of whether the monitoring system is to send, to the monitoring party, a confirmation of each notification message that is sent to a monitored subject by the monitoring system;

an indication of whether the monitoring system is to send, to the monitoring party, a confirmation of each correct response to a notification message that has been returned to the monitoring system by a monitored subject; and

an indication of whether the monitoring party (or other user) agrees to be billed separately for the provision of location-determination services by the monitoring system.

Additional sign-up screens 14 will also be presented to prompt the user for sign-up information to further configure the monitoring service specifically for each monitored subject. For each monitored subject, the sign-up information specific to that monitored subject will typically include at least a subset of the following data items, provided by way of example:

the monitored subject's mobile phone or mobile device number(s);

a first notification schedule defining times when a notification message is to be sent to the monitored subject, wherein the first notification schedule may be defined, for example, using specific user-defined dates and/or times, or time intervals between notifications (e.g. a number of minutes, hours, days, weeks);

a number indicating the times a reminder notification message is to be sent to the monitored subject after a given notification message is initially missed before a “non-response” system state is invoked for the monitored subject;

an alphanumeric string or code, or other response, that will be considered a correct response to a notification message sent to the monitored subject (e.g. “I'm OK”);

an amount of time (e.g. 1-200 minutes) that is permitted to elapse before another notification message is sent to the monitored subject when a given notification message sent to the monitored subject does not receive a response;

an amount of time to wait after the last reminder notification message has been sent to the monitored subject and the monitored subject has not responded, before a non-response system state is invoked for the monitored subject;

an alphanumeric string or code, or other response, that will be considered as an on/off toggle code allowing the monitored subject to activate and deactivate the monitoring service such that notification messages will or will not be sent to the monitored subject by affixing it to an on or off command (e.g. “on 333”, “off 333”);

an alphanumeric string or code, or other response that the monitored subject may provide to the monitoring system as a “trouble code” (e.g. “313”), which may, for example, allow the monitored subject to surreptitiously notify the monitoring party of a trouble situation, while deactivating the monitoring service such that notification messages will not be sent to the monitored subject;

an option to reset or change existing codes (e.g. on/off code, trouble code);

an indication of whether the monitored subject is permitted to send a pre-emptive message to the monitoring system, within a specified time period preceding the time at which an upcoming notification message is scheduled to be sent to the monitored subject, such that the upcoming notification message will be deemed to have already been responded to and will not be sent to the monitored subject;

a length of the time period preceding the time at which an upcoming notification message is scheduled to be sent to the monitored subject, during which the monitored subject may send the pre-emptive response message;

an indication of whether a monitored subject may send a supplementary message with a late response message (i.e. a response sent by the monitored subject after the non-response system state has already been invoked) to the monitoring system, where the supplementary message may be used to provide an explanation of why the response by the monitored subject was late, for example;

details of one or more alternate notification schedules, and one or more indications of whether the respective alternate notification schedule is to be employed when the monitored subject responds to a notification message that was sent in accordance with the default notification schedule or a different alternate notification schedule;

an indication of whether the monitoring system is to automatically transmit determined location information (e.g. indicating the geographical location of the mobile phone of the monitored subject) to the monitoring party when a monitored subject does not respond to the monitoring system; and

a length of time during which the monitoring party must acknowledge a non-response message sent by the monitoring system to the monitoring party (e.g. by sending a reply message), where the message informs the monitoring party that a non-response system state has been invoked for the monitored subject (the acknowledgement would typically identify the monitored subject to differentiate it from other acknowledgements that may be required from the same monitoring party).

Details of some of the data items identified above will be described in further detail below in this specification.

If the operator of the monitoring system wishes to verify the identity of a user who is registering for the monitoring service, the user may be sent a message in a data format (e.g. a text message or e-mail) via a mobile communication device of the user, to which the user must respond before the sign-up process can be completed.

The sign-up screens 14 may allow monitoring parties to input details associated with multiple monitored subjects to be monitored. The operator of the monitored service may charge additional fees when more than one monitored subject is to be monitored.

Once a user has registered for the monitoring service, the software 12 will display a home page 16 (FIG. 2) for the user when the user accesses the web site 10. The home page 16 will show the current status of the notification schedule for the monitored subject(s), and provides a user interface that permits the user to configure the monitoring service.

For example, the user may change the notification schedule for the monitored subject(s).

As a further example, the user may configure the monitoring service such that the monitoring service is activated for only a selected subset of the monitored subjects that have been identified during the sign-up process. Subsequently, in operation, notification messages would be sent to each selected monitored subject, but not to non-selected monitored subjects, in accordance with the corresponding notification schedule.

The user may be provided with a number of options, in which the monitoring service for a selected monitored subject is to be activated manually, or for a specific period of time. For example:

the monitoring service may be manually activated and deactivated for a specific monitored subject, in accordance with the settings (e.g. notification schedule) that were input during registration unless different ones have since been entered;

the monitoring service may be manually activated for a specific monitored subject, and configured to deactivate at a specific time or after a specified amount of time has passed; and

the monitoring service may be configured to automatically activate and deactivate at specific dates and/or times, or at dates and/or times that recur at a specified interval, either indefinitely or for a fixed length of time (e.g. to coincide with a regular schedule of activities associated with the specific monitored subject).

When the user accesses the web site 10, a summary of all of the current or default settings (e.g. non-response contact numbers, notification schedule details, activation and deactivation privileges, etc.) associated with one or more of the monitored subjects for which the monitoring service can be activated will typically be displayed to the user on home page 16 and/or other web pages accessible from home page 16.

Activation of the Monitoring Service

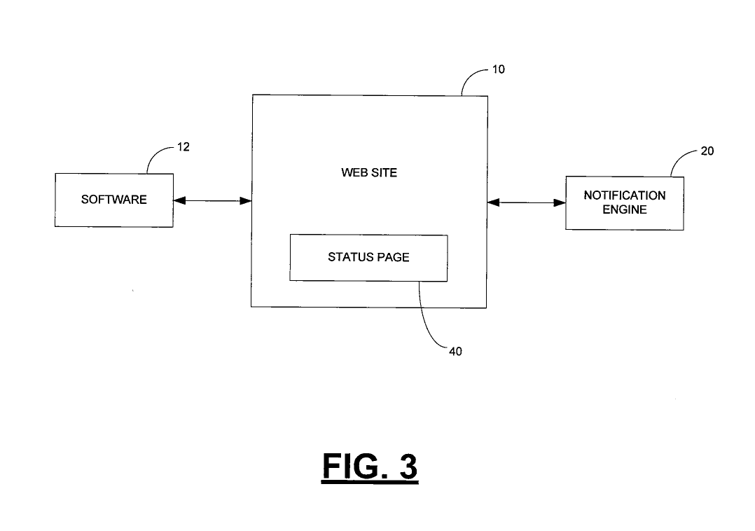

Referring now to FIG. 3, a schematic diagram illustrating a monitoring system in which the web site of FIGS. 1 and 2 is connected to a notification engine is shown.

After a user activates the monitoring service for one or more monitored subjects, a notification engine 20 of the monitoring system will be employed to send notification messages. Although software 12 and notification engine 20 are shown schematically as separate components in FIG. 3, the notification engine 20 will typically be implemented through one or more modules of software 12, although other configurations are possible in variant embodiments.

Generally, the notification engine 20 is programmed to process messages to be sent to monitored subjects and monitoring parties, and responses from the monitored subjects and monitoring parties. Modules in software 12 are programmed to monitor the web site 10 and determine when a user has manually activated (or deactivated) the monitoring service for a monitored subject. Modules in software 12 are also programmed to determine when the monitoring service for a monitored subject should be automatically activated in accordance with a notification schedule.

In a variant embodiment, the monitoring service may be configured to allow a monitored subject himself to activate and deactivate the monitoring service. This may be initiated by the monitored subject by sending a message command from his mobile phone to the notification engine 20 of the monitoring system. For example, an alphanumeric string or code (e.g. as defined during the registration process) combined with an on or off command, or other response (e.g. “on 333” or “off 333”) may be sent to the monitoring system. The monitoring service may also be configured to generate a message that will be sent to the monitoring party when a monitored subject has activated or deactivated the monitoring service.

Notification Messages

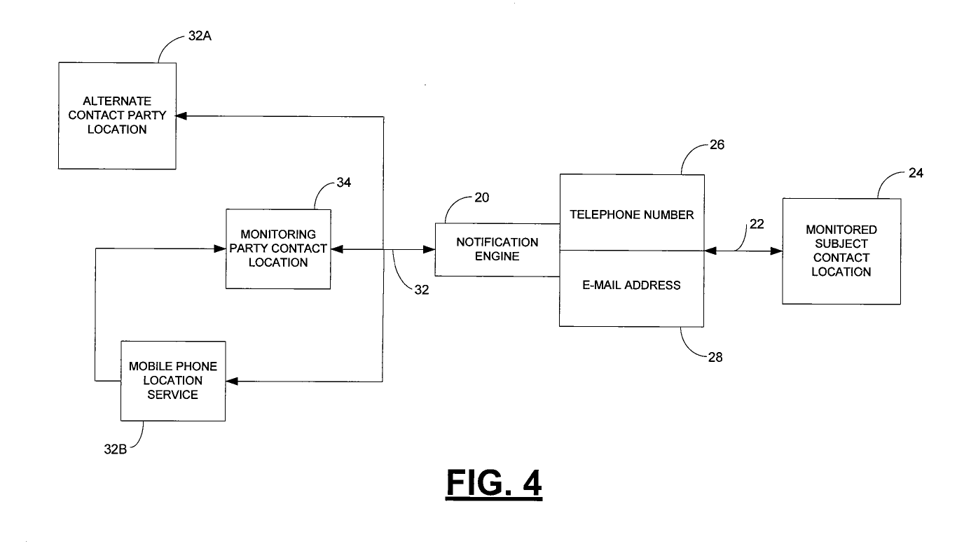

Referring now to FIG. 4, a schematic diagram illustrating the notification engine of FIG. 3 connected through communication links to contact locations of a monitored subject and a monitoring party is shown.

When the monitoring service has been activated such that notification messages are to be sent to a given monitored subject, the monitored subject will be sent notification messages by the notification engine 20 in accordance with the notification schedule associated with that monitored subject. Notification messages are transmitted over a communication link 22 to the contact location 24 for the monitored subject.

The contact location 24 for a monitored subject will be the monitored subject's mobile phone or other mobile communication device (e.g. personal digital assistant, pager). Notification messages sent by the notification engine 20 to the monitored subject are sent to a mobile communication device of the monitored subject, and any responses made by the monitored subject will be communicated back to the notification engine 20 via the mobile communication device.

Notification messages are data messages that are sent to the mobile communication device of the monitored subject. In one embodiment, the notification messages are in the form of text messages, so as to minimize their intrusiveness to the monitored subject. The text messages may be transmitted using SMS, WAP push, or some other protocol. Use of notification messages in a data format (e.g. text messages, e-mail) allows for greater flexibility in the provision of monitoring services, in that the monitored subject need not immediately attend to a notification message as soon as it is received on the mobile communication device. In contrast, systems that require a monitored subject to answer a telephone call or provide a voice-based response to notification messages would typically require a monitored subject to immediately attend to notification messages as they arrive in order to avoid triggering an alert condition.

The content of notification messages sent to monitored subjects may vary in variant embodiments. For example, the notification message may be a simple text message requiring the user to “check-in” by responding with a specific response.

As a further example, a notification message may pose a multiple choice question (e.g. “Have you felt chest pain in the last 24 hours? Reply with “1” for “yes” and “2” for “no”). Certain replies by the monitored subject may constitute a “correct” response to the notification message (e.g. “2”), which does not require the monitoring party to be alerted. However, other replies may constitute a response that results in an alert being sent to the monitoring party. Depending on the configuration of the monitoring service, the non-response system state and/or some other emergency system state may be automatically invoked when certain responses are received from the monitored subject.

In one embodiment, the notification messages are transmitted in the form of a data packet (e.g. using a Session Initiation Protocol or SIP), which upon receipt by the mobile phone or other mobile communication device, would trigger the execution or activation of an application on the receiving device. The application is programmed to display the notification message, along with possible response options including soft buttons for responding to the incoming notification message. This may provide mobile phones and other mobile communication devices with greater flexibility compared to known systems, and may allow monitoring services to be provided to users more efficiently, requiring minimal user intervention.

In some cases, notification messages may not be received by the monitored subject because the batteries of the monitored subject's mobile phone are dead, or because the mobile phone was out of the reception area. For example, there is often no mobile phone reception in deep building basements or in subway trains. However, most mobile phone systems operate in accordance with signaling protocols under which a mobile phone carrier can determine whether or not a particular mobile phone has received a call or messages. The carrier can pass this information to the notification engine 20, indicating whether or not the monitored subject's mobile phone has received a particular notification message. If the notification engine 20 receives a signal from the carrier that a notification message was not received by the monitored subject's mobile phone, then the monitoring system may, for example, continue operating as programmed, with notification messages being sent to the monitored subject in accordance with the notification schedule as the monitoring service has been configured. Optionally, the frequency with which further notification messages are sent may be increased. If the monitored subject's mobile phone does not receive a pre-determined number of notification messages, then the notification engine 20 may advise the monitoring party that the monitored subject may not have received the notification message. For instance, the notification engine 20 may notify the monitoring party by sending a non-response message (e.g. at the monitoring party contact location 34) as will be described in further detail below, advising that the monitored subject has not responded, and optionally, also advising that the reason that the monitored subject has not responded is due to the fact that the mobile phone of the monitored subject has been unable to receive the notification messages.

Typically, when a notification message is sent to a monitored subject, a message confirming that the notification message was sent to the monitored subject is not generated. However, the monitoring service may be configured, if desired, to generate messages confirming that a notification message has been sent to a monitored subject, and to send such messages to the monitoring party. The monitoring system may also be adapted to provide users with the ability to review a list of notification messages previously sent to monitored subjects and the status of each notification message in the list (e.g. whether or not the respective monitored subject has responded to the respective notification message).

Responses to Notification Messages by Monitored Subjects

Notification messages sent by the notification engine 20 to a monitored subject will generally require a response from the monitored subject. The monitored subject may respond by replying with an e-mail or a text message, to be processed by the notification engine 20. In order that the notification engine 20 can receive these replies, a telephone number or short code 26 for receiving text messages and/or an e-mail address 28 to receive e-mails is associated with the monitoring system.

A reply message may also be sent by pressing a single button on the mobile phone or other mobile communication device of the monitored subject. The button is pre-programmed so that a preset reply message is automatically composed and sent after the button is pressed. This would allow, for example, a monitored subject to respond with a choice of one of several possible responses with a push of a single button.

In one embodiment, the monitoring service may be configured to accept only certain responses as “correct”, as identified in the sign-up process. If a reply does not contain the correct response, the notification engine 20 may ignore that reply. The monitoring service may be configured to invoke a non-response system state, or a more urgent “emergency” system state, if multiple reply attempts are made, none of which contain the correct response. Certain responses may also immediately invoke the emergency system state.

For example, if the monitored subject replies to a notification message with an incorrect response (e.g. “I am op” instead of “I am ok”), the notification engine 20 may send a clarification request message to the monitored subject. The monitored subject is requested to resend a reply with the correct response. If the monitored subject does not respond to the clarification request message with the correct response, or again responds with an incorrect response, a non-response system state may be immediately invoked.

If the monitored subject replies to a notification message with a trouble code, the sending of notification messages may be suspended, and the monitoring party is notified that the monitored subject has voluntarily entered the trouble code. This may provide for additional security, as it allows the monitoring system to accommodate a possible danger situation in which the monitored subject is being forced to respond to a notification message, and where the monitored subject needs to surreptitiously trigger a non-response system state, which can be done by deliberately replying with the trouble code.

In one embodiment, the monitoring service may be configured so that the monitored subject is permitted to send a pre-emptive message to the monitoring system, within a specified time period preceding the time at which an upcoming notification message is scheduled to be sent by the notification engine 20 to the monitored subject. When the pre-emptive message is sent to the notification engine 20, the upcoming notification message that would have been sent will be deemed to already have been responded to, and as a result, that particular notification message will not be sent to the monitored subject.

Allowing monitored subjects to send pre-emptive messages provides a way for monitored subjects to more easily manage the notification messages they receive. False alarms may be avoided in situations where a monitored subject knows that they will be unable to respond to a notification message within a particular period. For example, the monitored subject may know that they will be in a location without wireless reception or will otherwise be unavailable to respond to the upcoming notification message.

In this embodiment, the time period preceding the time at which an upcoming notification message is scheduled to be sent is set by the user. Allowing a user to specify the time period ensures that the monitoring system is not misused by a monitored subject attempting to pre-empt a large number of messages in advance. A shorter time period may provide greater accuracy and be more useful to a monitoring party, while a longer time period may provide greater flexibility to a monitored subject.

Alternate Notification Schedules

In one embodiment, the monitoring service may be configured to employ one or more alternate notification schedules. The alternate notification schedule(s) will typically be different than the first or default notification schedule defined during sign-up.

In one example, an alternate notification schedule is employed after the monitored subject responds to a notification message that was sent in accordance with the default notification schedule. The next notification message is sent according to the alternate notification schedule, and the time that next notification message is sent may depend on the time the correct response to the previous notification message was received by the notification engine 20 from the monitored subject.

For example, the use of alternate notification schedules may have beneficial application in the management of pharmaceutical clinical trials, in which two medications are required to be taken by the monitored subject (e.g. patient), but the second medication can only be taken after the first medication is taken by the monitored subject, and possibly after a certain time period has elapsed after the first medication was taken. The alternate notification schedule may relate to a second dosage or drug, if the second dosage or drug must be taken after the first, and must be taken on a different schedule.

Supplementary Messages

In one embodiment, the monitoring service may be configured to allow a monitored subject to send a late response message, which is a reply from a monitored subject that is received after the non-response system state has already been invoked. A supplementary message, which may comprise text or a unique code associated with predefined text for example, may be sent with the correct response to a notification message, to the notification engine 20 by the monitored subject. The supplementary message may be used to offer a monitoring party some indication of the reason for the late response, or to provide details on when a related activity actually took place.

For example, in pharmaceutical clinical trial applications, consider a situation where the monitored subject (e.g. patient) responds late to a notification message. This might mean, for example, that either the medication was taken by the monitored subject late, or the medication was taken earlier but only the response by the monitored subject to the notification message was late. In the latter scenario, the supplementary message accompanying the late response message can be used to indicate the actual time that the medication was taken.

Additional Notification Messages Sent to Monitored Subjects

If a particular monitored subject does not reply to a notification message sent by the notification engine 20 within a pre-specified time limit, then the notification engine 20 can cause a non-response system state to be invoked immediately for that monitored subject, or it can send at least one further notification message to the monitored subject at some pre-specified time interval as a reminder. This pre-specified time interval may vary depending on the desired application. For example, a further notification message may be sent every minute, or every twenty minutes if desired, after the previous notification message was sent to the monitored subject. In certain circumstances, a longer time interval, such as 24 hours for example, may be reasonable (e.g. where it is known that the monitored subject will be unavailable for that longer period).

The monitoring service can be configured (e.g. using the sign-up screen 14 of FIG. 1 and/or the home page 16 of FIG. 2) so for example, one, two or three notification messages can be sent to the monitored subject and not replied to, before the non-response system state is invoked.

Generally, whether a non-response system state is to be invoked immediately after a first notification message has not been received from the monitored subject (within the pre-specified time limit) or only after at least one further notification message has been sent and is not replied to by the monitored subject, will depend on the monitoring service settings, as configured by the user of the monitoring system (e.g. the monitoring party). The time interval defining when the further notification messages, if any, are to be sent will also be identified in the monitoring service settings. When desired, the user may define a new time limit or interval by reconfiguring the monitoring service (i.e. changing the monitoring service settings, through home page 16 of FIG. 2 for example).

In a variant embodiment, if the monitored subject does not reply to a notification message sent by the notification engine 20, the notification engine 20 is programmed to send notification messages to the monitored subject at an increased frequency automatically, without user intervention. The frequency can be customized, as desired. For example, consider when a monitored subject fails to reply to a notification message, where additional notification messages are being sent at one hour intervals. After the first missed notification message, the frequency at which subsequent notification messages are sent to the monitored subject can be increased to once every fifteen minutes until the monitored subject replies, and if two of such subsequent messages are missed, then the frequency at which subsequent notification message are sent to the monitored subject can be further increased to once every two minutes until the monitored subject replies. The frequency settings can be varied in accordance with any desired pre-specified schedule, and it will be understood by persons skilled in the art that the foregoing frequency schedule is provided by way of example only.

Generally, a notification schedule may be defined by a user of the monitoring system (e.g. a monitoring party) in configuring the monitoring service, to determine such variables as the number of notification messages that the monitored subject does not reply to before the increased frequency of notification message transmissions is triggered, the intervals at which the notification messages are sent when the increased frequency rate is triggered, and whether any non-linear acceleration in the rate of increase in the frequency of sending notification messages is to be employed, for example. The monitoring service may also define pre-set defaults for these variables.

Non-Response System State and Non-Response Messages

If a non-response system state has been invoked for a particular monitored subject, namely when the monitored subject has not responded to any of a pre-specified number of notification messages sent to that monitored subject, then the notification engine 20 will send a non-response message over communication link 32 to the monitoring party contact location 34, advising that the particular monitored subject has not responded.

As with notification messages sent to a monitored subject, non-response messages sent by the notification engine 20 to a monitoring party (or alternate contact as discussed below) are sent to a mobile communication device of the monitoring party (or alternate contact), and any replies will be communicated back to the notification engine 20 via the mobile communication device. The non-response message sent to the monitoring party can be sent, for example, by e-mail, or as a text message to a mobile phone, pager, or other mobile communication device, using SMS, WAP push, or other protocol.

When the non-response system state has been invoked, the notification engine 20 will suspend all future schedules for sending notification messages to the monitored subject, until such time as the monitored subject replies with the correct response, or until a user (e.g. the monitoring party) resets the system so as to cancel the non-response system state and return back to a normal operating state. Suspending all future schedules prevents a situation where a parent may erroneously believe that the last non-response condition has been resolved (e.g. the monitoring subject responded late) because notifications messages are being sent in accordance with a new schedule, when in fact the non-response system state for the monitoring subject is still in effect.

In the non-response message sent to the monitoring party, the monitoring party will be directed to send an acknowledgement to the non-response message by replying with a specified response (e.g. “ok child”). Typically, a reply to a non-response message must be received from the monitoring party, in order to acknowledge that the system has entered a non-response state. If the monitoring party does not reply to the non-response message with the expected response within a certain time period, the system may send the monitoring party another non-response message as a reminder. Further reminders may be sent, with the maximum number of reminders dependent on the monitoring service settings as configured (e.g. between 2 to 100 reminder messages).

In one embodiment, the user of the monitoring service may identify an alternate contact party, where the contact details of the alternate contact party are provided by the user when configuring the monitoring service. Accordingly, if the monitoring party still has not replied to the non-response message sent by the notification engine after all of the maximum number of reminders have been sent, a non-response message will be sent by the notification engine 20 to the alternate contact party at alternate contact location 32A, who will similarly be asked to send an acknowledgement to the non-response message by replying with a specific response.

More than one alternate contact may be identified [other alternate contact locations not shown in FIG. 4] to which the notification engine 20 may send a non-response message, either contemporaneously with the non-response messages sent to the other alternate contacts or otherwise, in accordance with a schedule, for example.

Moreover, further non-response messages may also be sent to one or more alternate contact parties as reminders.

In another embodiment, non-response messages may also be sent to one or more alternate contact parties after only a pre-determined subset of the maximum number of reminders have been sent, if the monitoring service is so configured. In that case, the notification engine 20 may continue to send non-response messages to the monitoring party while it also sends one or more non-response messages to the one or more alternate contact parties.

In one embodiment, when the monitoring party and/or an alternate contact party replies to a non-response message with the expected response, all of the parties that had received a non-response message will be sent a message identifying the monitoring party or alternate contact party who replied.

The ability to identify alternate contact parties allows one or more “backups” to be contacted in the event that a primary contact (i.e. the monitoring party) does not acknowledge a non-response alert after a specified number of attempts. This feature may provide additional security. The alternate contact parties are kept informed as to whether the monitoring party has responded to a non-response message, and whether the monitored subject has properly responded to the notification message since the non-response state was invoked.

Return to Normal Operating State

In one embodiment, if the monitored subject provides the correct response to a notification message while the monitoring system is in the non-response system state, all of the monitoring parties that had received a non-response message will be notified of this event, and the monitoring system will exit the non-response system state and return back to a normal operating state.

In a variant embodiment, the monitoring system may cancel a non-response system state and return back to a normal operating state on its own accord, without intervention by the user (e.g. the monitoring party), an alternate contact party, or a monitored subject.

For example, once a certain amount of time has elapsed from the time the non-response system state was first invoked and/or once a certain time threshold in the day (e.g. 11:59 pm) is reached, the non-response system state may be considered to have “timed-out”. With the “time-out” condition for the non-response system state satisfied, the monitoring system returns back to a normal operating state.

Location Determination

In one embodiment, the monitoring service can be configured such that when a non-response system state is invoked, a mobile phone location service 32B can be activated. For example, the notification engine 20 can send a request to a mobile phone location service 32B to initiate a determination of the geographical location of the mobile phone of the monitored subject, using satellite technology (e.g. Global Positioning System) or other Location Based Services (LBS) location determination technology. The location information provided by the mobile phone location service 32B can then be sent to a monitoring party (and/or an alternate contact party).

The mobile phone location service 32B can also be activated under other circumstances, even when a non-response system state has not been invoked. The ability for a monitoring party to locate the whereabouts of a monitored subject may provide additional security.

The mobile phone location service 32B may be, more generally, a mobile communication device location service.

Activity Reports, Help Guides, and Billing

Referring again to FIG. 3, the web site 10 may provide user access to a status page 40, which shows a log of all monitoring service activity within a specific date range. The status page 40 may include the following information, provided by way of example:

a time entry (e.g. date and time) identifying when the monitoring service has been activated for a particular monitored subject, and the notification schedule for the sending of notification messages to that monitored subject;

a list entry for each notification message sent to the monitored subject, whether it was received by the monitored subject's mobile phone, and whether the monitored subject replied to the respective notification message;

a time entry identifying when the last notification message sent to the monitored subject was replied to;

an entry identifying any non-response messages that have been sent to the monitoring party and/or any alternate contact parties; and

an entry identifying when and who has deactivated and/or reset the monitoring service for the monitored subject.

A summary of the information that would be provided on a status page 40 may also be retrieved by a monitoring party from a mobile phone, via an SMS message, WAP push message, a data packet which may be presented as an IP-based “web page”, or an e-mail message, for example. This summary may be sent at the request of the monitoring party, or a session summary may be automatically sent when a notification schedule for a particular monitored subject reaches its end. Accordingly, when a notification schedule ends, the monitoring party can expect to receive the session summary as a final communication as to the safety or status of the monitored subject if the non-response system state has not been invoked.

The information to be provided on a status page 40, as well as other information pertaining to the settings of a configured monitoring service, can be stored in a database. Furthermore, past history information is typically also stored in the database. For example, the database may be employed to keep track of the activity history for each monitored subject, covering a minimum period of 24 hours. Details of an activity history may include, for example, information on the monitored subject (e.g. name, mobile phone number, notification message details), whether or not notification messages were received by the monitored subject's mobile phone, details of responses to notification messages, the number of missed and late responses, who was notified of the missed and/or late responses, and whether an acknowledgement message to a non-response message was received from a monitoring party or alternate contact party.

The web site 10 may also provide access to help pages [not shown], comprising a guide to each section of the web site 10, and a printable guide to the commands used to control the operation of the notification engine 20.

The web site 10 may also display how many months of monitoring service use have been billed for, and an option for a monitoring party or other user to renew. An operator of the web site 10 may handle regular billing and payments, and the payments less an administration fee may be remitted to the mobile device carrier.

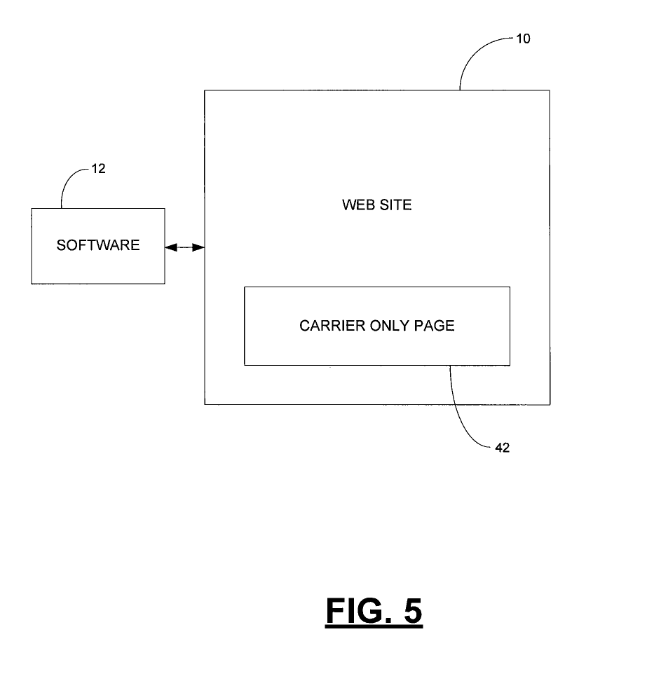

Referring now to FIG. 5, a schematic diagram illustrating a monitoring system comprising the web site of FIGS. 1 and 2 in accordance with another embodiment is shown.

Where the monitoring system is operated by a mobile device carrier, such as a mobile phone carrier for example, the carrier can be given access to a “carrier only” page 42 on the web site 10, which provides information on use of the monitoring service by users (e.g. the monitoring party). Typically, the carrier only page 42 will be password-protected.

The “carrier only” page may provide the following information, for example:

the number of paying users;

the number of cancelled users;

the number of users who currently subscribe to the monitoring service;

the telephone number of a particular user;

the status (e.g. active, non-active) of a particular user; and

the amount billed to a particular user for a given billing period.

The carrier can view user-specific information either by inputting the user's telephone number, or by clicking a link provided within the aggregate data shown on the carrier only page 42 to access an index of individual users, for example.

Information may be provided to carriers that indicate which users are no longer using the monitoring service, so that a web site operator, for example, can disable accounts (e.g. on a daily basis). User data may be stored for a certain period of time (e.g. one year) to enable users to reactivate their accounts during that period without having to re-enter all of their user information. A separate page for re-enabling disabled accounts [not shown] may be provided for this purpose.

An administrator of the web site may also disable user accounts and prevent access to the monitoring system (e.g. if a user has not paid). The monitoring system may be adapted to provide the administrator with reports concerning details of the use of the monitoring system, which may include, for example, total users, total active users, a list of users and the number of times the monitoring system has been accessed by each user, the total number of accesses per user in a given period (e.g. per month or per year), and revenue details.

Examples of Method Embodiments

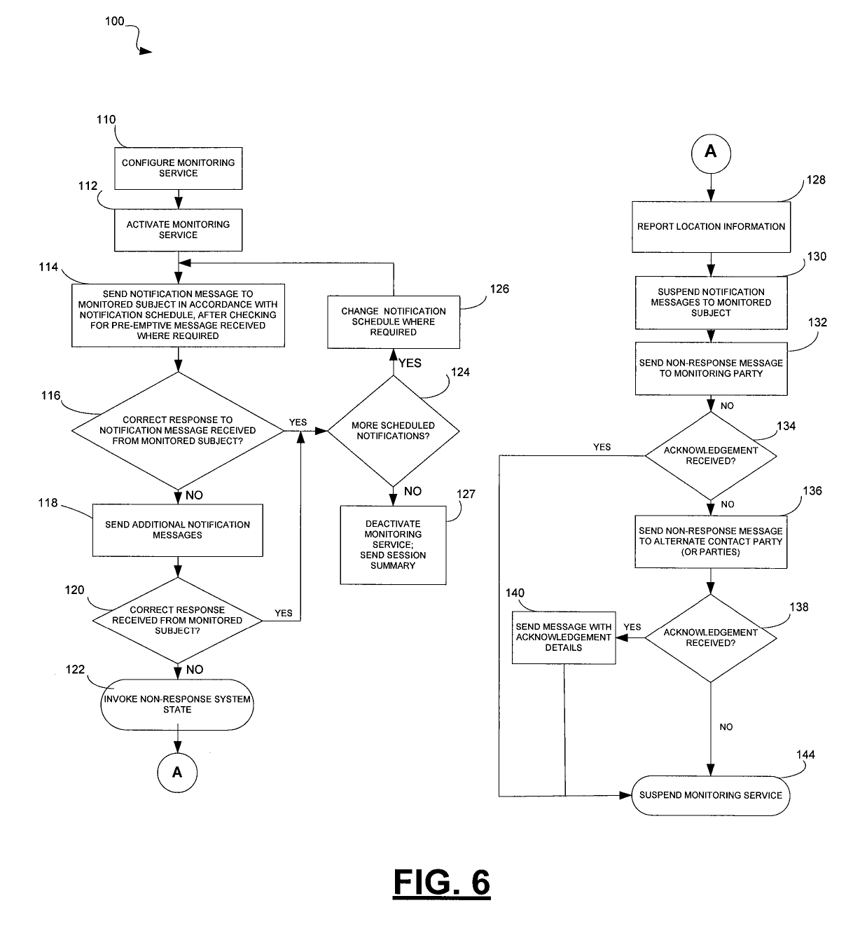

Referring now to FIG. 6, a flowchart illustrating steps in a method of monitoring a monitored subject in at least one embodiment is shown generally as 100. Additional details in respect of at least some of the steps of method 100 have been provided earlier in this description.

For ease of exposition, the steps of method 100 are directed to a service where a monitoring party wishes to monitor a single monitored subject. However, it will be understood by persons skilled in the art that multiple monitored subjects can be monitored.

At step 110, the monitoring service is configured. At this step, the user of the monitoring system, typically the monitoring party, inputs the settings to control notification schedules and other options related to the operation of the monitoring service in respect of the monitored subject. General configuration settings may also be determined at this step. This step may be repeated later [flow not shown] if the monitoring party wishes to change the settings after they have been initially provided. Default values may also be assigned by the monitoring system, which may or may not be changed.

At step 112, the monitoring service is activated, to commence monitoring of the monitored subject. Typically, this will be initiated by the monitoring party (either manually, or automatically after an initial configuration of the monitoring service by the monitoring party), although in a variant embodiment, the monitored subject may also activate the monitoring service. In that variant embodiment, a message indicating that the monitored subject has activated the monitoring service may be sent to the monitoring party.

At step 114, a notification message is sent to the monitored subject (e.g. by a notification engine 20 as shown in FIGS. 3 and 4) via a mobile communication device of the monitored subject in accordance with a notification schedule, the details of which were provided during the configuration of the monitoring service at step 110.

At step 116, it is determined (e.g. by the notification engine 20) whether a response to the notification message sent at step 114 has been received from the monitored subject via the mobile communication device of the monitored subject, within the time allotted for such a response.

If a correct response to the notification message has not been received from the monitored subject within the allotted time, optionally, a number of additional notification messages may be sent to the monitored subject at step 118, depending on the configuration of the monitoring service. In some implementations, the number and the frequency of the additional notification messages may be configured by the monitoring party.

At step 120, it is determined whether a response to an additional notification message has been received from the monitored subject, within the time allotted for such a response.

If a correct response to a notification message still has not been received from the monitored subject within the allotted time, a non-response system state is invoked at step 122, to be described in further detail below.

In some instances, a response from the monitored subject may be received, but it may not be a “correct” response, which was defined when the monitoring service was configured. Typically, only one correct response is expected, although multiple correct response may be defined in variant embodiments.

Where a correct response is not received, optionally, a clarification request message may be sent to the monitored subject, requesting that the monitored subject resend a reply with the correct response. In one embodiment, if a correct response is not provided in reply to the clarification request message within a pre-specified number of attempts, the non-response system state may be invoked (with the flow of method steps proceeding to step 122), and the monitoring party is alerted to the incorrect responses received. This may be helpful in alerting the monitoring party to a potential emergency situation, as described earlier in this description.

If at either step 116 or step 118, it is determined that a correct response has been received from the monitored subject, the flow of method steps proceeds to step 124.

At step 124, it is determined whether any more notification messages are scheduled to be sent to the monitored subject. If so, the flow of method steps proceeds to step 126. If not, then the monitoring service is deactivated at step 127, and optionally, a report may be sent to the monitoring party.

At step 126, optionally (depending on the configuration of the monitoring service), operation of the monitoring service may continue in accordance with an alternate schedule for sending subsequent notification messages to the monitored subject. Alternatively, where the prior notification message had already been sent in accordance with an alternate schedule, operation of the monitoring service may continue in accordance with a further alternate schedule, or the original schedule may be re-established to send subsequent notification messages to the monitored subject. Method 100 then continues from step 114.

Referring again to step 122 where a non-response system state has been invoked, steps 128 to 144 of method 100 [marked under “A” in FIG. 6] are initiated.

At step 128, optionally, a request may be made to a mobile phone location service to determine the location of the monitored subject's mobile phone. This location information can then be reported to a monitoring party, and potentially, to one or more alternate contact parties as described below, either within a non-response message or in a separate message.

At step 130, the sending of notification messages to be sent to the monitored subject is suspended.

At step 132, a non-response message is sent to the monitoring party, to the mobile communication device of the monitoring party.

At step 134, it is determined whether the monitoring party has acknowledged the non-response message sent at step 132 by responding with the pre-specified correct response. If the non-response message sent at step 132 is not acknowledged within a pre-specified amount of time, additional reminders may be sent to the monitoring party [not explicitly shown in FIG. 6]. If the non-response message is acknowledged, the monitoring service is suspended or deactivated as shown at step 144, awaiting re-activation by the monitoring party or other user (e.g. in which the flow of method steps may proceed back to step 112). In a variant embodiment, the monitoring service may be automatically re-activated from a non-response system state to a normal operating state after a “time-out” condition has been satisfied.

If the monitoring party has not acknowledged the non-response message, one or more alternate contact parties may also be sent a non-response message at step 136 (via mobile communication devices of the alternate contact parties), where alternate contact details have been provided in the configuration of the monitoring service.

As step 138, it is determined whether the monitoring party or an alternate contact party has acknowledged the non-response message. If so, a message is sent to at least the other parties who received a non-response message. The message informs the other parties of the identity of the person who replied with the acknowledgment. The flow of method steps proceeds to step 144, where the monitoring service is suspended as described above.

If the non-response message sent at step 136 is not replied to within a pre-specified amount of time, additional reminders may be sent to the alternate contact party or parties [not explicitly shown in FIG. 6].

In one embodiment, the monitoring service is suspended even if an acknowledgment is not received from the monitoring party or an alternate contact party. In a variant embodiment, some other action may be initiated in this event (e.g. an emergency number is called).

While not shown explicitly in FIG. 6, in one embodiment, if the monitored subject responds to a notification message at any time while the system is in a non-response state, the state is cancelled and the system returns to a normal operating condition, with the flow of method steps proceeding back to step 124. A reason for the late response in the form of a supplementary message may accompany the response from the monitored subject, which can be communicated to the parties that have received a non-response message while the system was in a non-response state (e.g. the monitoring party and potentially one or more alternate contact parties).

Although embodiments described herein primarily depict use of the monitoring service by one monitoring party to monitor one or more monitored subjects, in variant embodiments, the monitoring service may be configured for use by multiple monitoring parties in variant embodiments. For example, the monitoring service may be configured to allow several monitoring parties to monitor a single monitored subject, with one monitoring party identified as the “active” monitoring party for one notification schedule or one portion of a notification schedule, and another monitoring party identified as the “active” monitoring party for a different notification schedule or a different portion of a notification schedule. As a further example, the monitoring service may be configured to allow several monitoring parties to monitor several monitored subjects as independent set-ups, allowing some monitored subjects to be monitored by one monitoring party, and some other monitored subjects to be monitored by a different monitoring party.

It will be understood by persons skilled in the art that the specific wireless messaging protocols identified herein are provided by way of example only, and other wireless protocols may be used to transmit messages in variant embodiments. Moreover, where reference is generally made to a “mobile phone” herein, this is intended to include other mobile communication devices.

It will also be understood by persons skilled in the art that where reference has been made to a page or screen (e.g. a web page such as a sign-up screen, a home page, a status page, or a “carrier only” page), the page or screen may comprise multiple documents, and possibly links embedded therein. In particular, the term page or screen shall not be construed as being limited to a single document.

In the embodiments described herein, the monitoring service is described as being configured through a web site. However, the monitoring service may also be configured through other means, including for example, by e-mail from a mobile phone with e-mail capabilities, by text messaging, or other communication means from a mobile phone or other mobile communication device, in variant embodiments.

The steps of a method of monitoring a monitored subject in embodiments described herein may be provided as executable software instructions stored on computer-readable media, which may include transmission-type media.

The headings employed in the description are provided to the reader for ease of reference only, and are not to be used to limit the scope of the invention as defined in the claims appended hereto.

The invention has been described with regard to a number of embodiments. However, it will be understood by persons skilled in the art that other variants and modifications may be made without departing from the scope of the invention as defined in the claims appended hereto.

1. A method of monitoring a monitored subject comprising the steps of:
activating a monitoring service to send notification messages to the monitored subject;
sending at least one notification message to the monitored subject, via a mobile communication device, in accordance with a first notification schedule;
determining if a response to the at least one notification message sent at the sending step is received from the monitored subject via the mobile communication device within a pre-specified time period; and
invoking a non-response system state when a response to the at least one notification message is not received from the monitored subject within the pre-specified time period, wherein a non-response message is sent to a monitoring party at the invoking step.

2. The method of claim 1, wherein the at least one notification message sent to the monitored subject at the sending step is in a data format.

3. The method of claim 1, wherein the invoking step is performed only when a correct response to the at least one notification message is not received from the monitored subject within the pre-specified time period.

4. The method of claim 1, wherein the invoking step is performed after receiving a pre-specified number of incorrect responses.

5. The method of claim 1, further comprising the step of sending a message to the monitoring party when a response to the at least one notification message has been received from the monitored subject within the pre-specified time period.

6. The method of claim 1, further comprising the step of requesting the determination of the location of the mobile communication device of the monitored subject.

7. The method of claim 6, wherein the step of requesting the determination of the location of the mobile communication device of the monitored subject comprises requesting location information from a mobile communication device location service.

8. The method of claim 7, wherein the requesting step comprises transmitting one of a data packet and an electronic message to the mobile communication device location service.

9. The method of claim 1, further comprising the step of determining if an acknowledgment to the non-response message is received from the monitoring party within a pre-specified time period.

10. The method of claim 9, further comprising the steps of sending a non-response message to one or more alternate contact parties if the acknowledgement to the non-response message is not received from the monitoring party within a pre-specified time period, and determining if an acknowledgement to the non-response message is received from at least one alternate contact party within a pre-specified time period.

11. The method of claim 10, further comprising the step of sending a confirmation message to at least one of the one or more alternate contact parties and the monitoring party, the confirmation message indicating the party who acknowledged the non-response message.

12. The method of claim 1, wherein the activating step is performed by the monitored subject.

13. The method of claim 12, wherein the activating step is performed by the monitored subject in response to a message received from the monitored subject via the mobile communications device.

14. The method of claim 13, wherein the message received from the monitored subject is in a data format.

15. The method of claim 12, further comprising the step of sending a message to the monitoring party when the activating step is performed by the monitored subject.

16. The method of claim 1, further comprising deactivating the monitoring service.

17. The method of claim 16, wherein the deactivating step is performed by the monitored subject.

18. The method of claim 1, wherein at least the sending step is repeated, but wherein the sending step comprises sending at least one notification message to a monitored subject in accordance with an alternate notification schedule.

19. The method of claim 18, wherein the step of sending at least one notification message to a monitored subject in accordance with an alternate notification schedule is performed only if a response has been received to a previous notification message sent to the monitored subject in accordance with the first notification schedule.

20. The method of claim 1, further comprising the step of sending the monitoring party a supplementary message received from the monitored subject with a correct response to a notification message, the supplementary message having been sent by the monitored subject after the non-response system state has been invoked.

21. The method of claim 1, wherein the sending step is performed only if a pre-emptive message has not been received within a pre-specified time preceding a time in which the at least one notification message is to be sent to the monitored subject in accordance with the first notification schedule.

22. The method of claim 1, wherein the monitored subject responds to a notification message by pressing a single button on the mobile communication device of the monitored subject.

23. The method of claim 1, further comprising the step of returning to a normal operating state once the monitored subject responds to the at least one notification message after a non-response system state has been invoked.

24. The method of claim 1, further comprising the step of returning to a normal operating state once a time-out condition is satisfied after a non-response system state has been invoked.

25. The method of claim 1, further comprising the step of sending a session summary to the monitoring party.

26. The method of claim 1, wherein at least one notification message comprises a multiple-choice question.

27. The method of claim 26, further comprising sending the monitoring party an alert message when the monitored subject responds to the notification message with a pre-specified answer to the multiple-choice question.

28. A system for monitoring a monitored subject, comprising a notification engine programmed to perform the steps of the method as claimed in claim 1.

29. A computer-readable medium comprising instructions for performing the steps of the method as claimed in claim 1.
